(19) United States
(12) Patent Application Publication
(10) Pub. No.: US 2004/0131817 A1
(43) Pub. Date: Jul. 8, 2004

(54) Sheet of affixing labels

(76) Inventor: Kazumasa Nagafuchi, Tarumi-ku (JP)

Correspondence Address: JORDAN AND HAMBURG LLP, 122 EAST 42ND STREET, SUITE 4000, NEW YORK, NY, 10168, US

(21) Appl. No.: 10/705,630

(22) Filed: Nov. 10, 2003

(30) Foreign Application Priority Data
Dec. 12, 2002 (JP) 2002-361273

(51) Int. Cl. B32B 9/00

(52) U.S. Cl. 428/40.1

(57) ABSTRACT

This invention provides a sheet of affixing labels comprising a label sheet which has a layer of adhesives coated on the back surface of a sheet of paper and a releasing sheet, which has a layer of clay coated on the front surface of a sheet of paper, said layer of clay being further coated with a layer of releasing agents of silicon. The releasing sheet preferably has the back surface coated with a layer of clay. The sheet of affixing labels is prevented from being curled, waved and broken, when used by means of a copying machine, laser printer, etc. Also, the sheet of affixing labels is prevented from the label sheet being fallen from the releasing sheet, when used by means of a copying machine, laser printer in which toners are to be fixed at high temperature, and in which the sheet is to be reciprocated and turned round.

### BACKGROUND OF THE INVENTION

This invention relates to a sheet of affixing labels which comprises a label sheet having a back surface applied with a layer of adhesives and a releasing sheet affixed to the surface of the layer of adhesives of the label sheet.

As to former sheets of affixing labels, there was a superposed sheet which comprised a label sheet made of polyester resin film or paper which had the back surface applied with a layer of adhesives and a releasing paper which had a sheet of paper laminated with polyethylene film on which a layer of releasing agents of silicon was further formed.

However, when the superposed sheet was used by means of a laser printer, etc., because of the temperature for fixing toners being so high as to be 150 to 200° C., polyethylene film of the releasing paper laminated for the purpose of preventing silicon from permeating in the paper was thermally deformed, and the superposed sheet curled and waved. Also, the label sheet was easily broken at gaps between labels.

Also, other than the foregoing, the superposed sheet had defects that labels were easily fallen off from the label sheet, when used by means of a small-sized laser printer, etc. in which the superposed sheet was to be reciprocated and turned round.

### SUMMARY OF THE INVENTION

Then, as a result of profound study, this inventor has found that if polyethylene film, which was undercoating substance for releasing agents of silicon of the releasing paper, was replaced with a layer of clay, and preferably, if the back surface of the releasing paper was coated with a layer of clay, it was possible for the sheet to be prevented from curling or waving, when kept in the custody, or after copying.

Furthermore, this inventor has found that if the label sheet having gaps between labels was prepared to be heavier than the releasing paper, it was possible for the label sheet to be prevented from being broken, when toners were fixed.

Also, if the total thickness of the superposed sheet was limited in a certain range, when the sheet was reciprocated and turned round in a copying machine, laser printer, etc., in which toners were fixed at high temperature, it was possible for labels to be prevented from being fallen off from the releasing sheet. Thus, the inventor has completed this invention.

Namely, this invention provides a sheet of affixing labels which is prevented from curling, waving or being brocken, when used by means of a copying machine, laser printer, etc., in which toners are to be fixed at high temperature.

Also, this invention provides a sheet of affixing labels which prevents labels from being fallen off from the releasing paper, when used by means of a copying machine, laser printer, etc. in which the sheet is to be reciprocated and turned round.

For the purpose of accomplishing the above-mentioned problems, the sheet of affixing labels according to the present invention, as shown in FIG. 1, comprises a label sheet having a layer of adhesives 30 coated on the back surface of a sheet of paper 10 and a releasing sheet having a layer of clay 50 coated on the surface of a sheet of paper 40, said layer of clay 50 being further coated with a layer of releasing agents of silicon 60.

For the purpose of accomplishing the above-mentioned problems, the sheet of affixing labels according to the present invention, as shown in FIG. 2, comprises a label sheet having a layer of adhesives 30B coated on the back surface of a sheet of paper 10B and a releasing sheet having a layer of clay 70 coated on the back surface of a sheet of paper 40B and a layer of clay 50B coated on the front surface of the sheet of paper 40B, said layer of clay 50B further coated with a layer of releasing agents of silicon 60B.

For the purpose of accomplishing the above-mentioned problems, the sheet of affixing labels according to the present invention, as shown in FIG. 3, comprises a label sheet made of polyester synthetic resin film 10C, which has the front surface coated with a layer of matting agents 20C including anti-static agents and fine particles 21C and the back surface coated with a layer of adhesives 30C, and a releasing sheet made of a sheet of paper 40C which has the front surface coated with a layer of clay 50C, said layer of clay 50C further coated with a layer of releasing agents of silicon 60C.

For the purpose of accomplishing the above-mentioned problems, the sheet of affixing labels according to the present invention, as shown in FIG. 4, comprises a label sheet made of polyester resin film 10D, which has the front surface coated with a layer of matting agents 20D including anti-static agents and fine particles 21D and the back surface coated with a layer of adhesives 30D, and a releasing sheet made of a sheet of paper 40D which has the back surface coated with a layer of clay 70D and the back surface coated with a layer of clay 50D, said layer of clay 50D being further coated with a layer of releasing agents of silicon 60D.

In the present invention, clay includes all kinds of well known clay.

Clay is coated on a surface or both surfaces of a sheet of paper, and the thickness of respective layers of clay is preferably 5 microns to 15 microns. If the thickness is less than 5 microns, the releasing sheet becomes to be easily bent, and the releasing sheet is easily broken at gaps, when toners are fixed at high temperature. Also, it becomes difficult for the sheet of affixing labels according to the present invention to pass through a copying machine, laser printer, etc. Also, if the thickness of the releasing sheet is more than 15 microns, it becomes difficult for the sheet of affixing labels to be reciprocated and turned round.

Also, in the present invention, polyester resin film having the thickness of 38 microns to 75 microns is used.

As to paper for labels, ordinary wood free paper, kraft paper, etc. can be used in the present invention in accordance with the place in which the labels are to be used. However, in cases when used outdoors, other than well known kinds water-resisting paper, such a kind of paper as described in the publication of Japanese unexamined patent application No. 2002-69890 is preferably used. The paper has what is called the water absorbing capacity of the cob of less than 30 g/m². Since the paper treated so that water may not permeate in it, and so that the paper may be prevented from lowering the strength and from changing the size, the paper has such property as surface strength, ink being easily dried, etc. suitable for offset printing. Also, the paper is easily dissociated, when the paper is to be reused.

As to paper used in the releasing sheet, wood free paper, glassine paper, parchment papar, etc. having the weight of 81.4 g/m² to 128 g/m² are commonly used.

As to matting agents, if polyester synthetic resin film is to be used for labels, fine particles of silica, synthetic resins, etc. having an average grain size of less than 0.4 microns are commonly used.

Also, the layer of releasing agents of silicon is commonly coated at the thickness of 3 microns to 5 microns.

The total thickness of the sheet of affixing labels is preferably less than 250 microns, when used by means of high speed copying machine, laser printer, etc. in which toners are to be fixed at the temperature of more than 150° C., and in which the sheet of affixing labels is reciprocated and turned round.

As to adhesives used in the present invention, all of well known adhesives are included, however, acryl emulsion, natural rubber latexes, etc. are preferable.

### BRIEF DESCRIPTION OF THE DRAWINGS

FIG. 1 is an enlarged diagram showing a section of an example of the present invention.

FIG. 2 is an enlarged diagram showing a section of another example of the present invention.

FIG. 3 is an enlarged diagram showing a section of another example of the present invention.

FIG. 4 is an enlarged diagram showing a section of another example of the present invention.

### DESCRIPTION OF THE PREFERRED EXAMPLES

### EXAMPLE 1

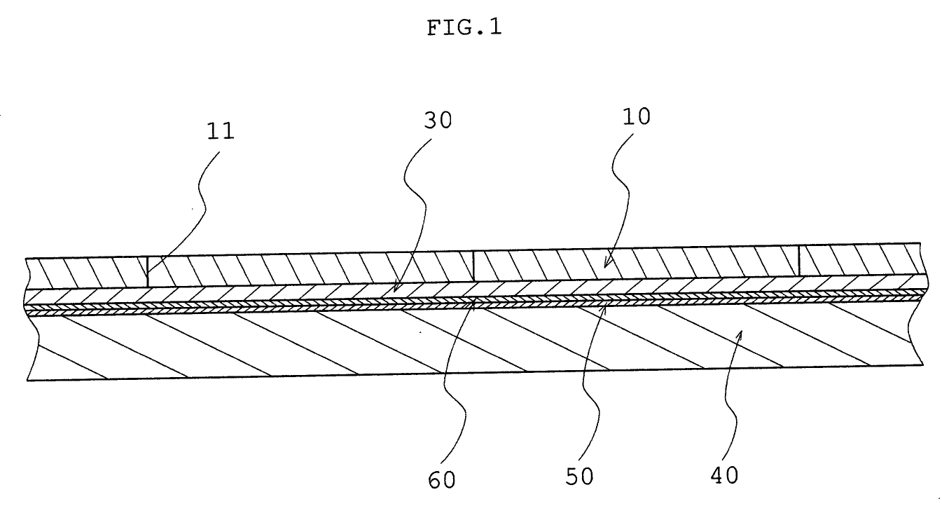

Example 1 of the present invention is shown in FIG. 1.

The sheet of affixing labels according to this example of the present invention comprised a label sheet having a layer of adhesives 30 coated on a sheet of paper 10 and a releasing sheet in which the front surface of a sheet of paper 40 was coated with a layer of clay 50, and further coated with a layer of releasing agents of silicon 60.

The label sheet comprised a sheet of water-resisting paper 10 having the thickness of about 50 microns and the water absorbing capacity of the cob of less than 30 g/m², and the back surface of the sheet of water-resisting paper 10 was coated with a layer of adhesives of acryl resin 30, and the total thickness was 71 microns, and the weight of the label sheet was 60 g/m². 11 showed a gap of the sheet of paper 10. The releasing sheet comprised a sheet of wood free paper 40 having the thickness of 40 microns and having a layer of clay 50 coated on the surface of the sheet of paper, said layer of clay 50 being further coated with a layer of releasing agents of silicon 60 having the thickness of 3 microns. The total thickness of the releasing sheet was 89 microns, and the weight was 80 g/m².

The sheet of affixing labels according to the example of the present invention had the thickness of 160 microns, as the releasin sheet was superposed on the label sheet, and the releasing sheet was prepared so as to be heavier that the label sheet.

Accordingly, in the sheet of affixing labels according to the example of the present invention, since the releasing sheet has a layer of clay 50 on the surface of the sheet of paper 40, the sheet of affixing labels did not easily curl nor wave, when kept in the custody, and also, the sheet of affixing labels had the total thickness of 160 microns, separation of the releasing sheet from the label sheet did not occur, when used by means of a copying machine, laser printer, etc. in which the sheet of affixing labels was to be reciprocated and turned round.

Also, since the sheet of affixing labels according to the example of the present invention did not comprise thermoplastic substance, the sheet did not curl nor wave, when toners were fixed at high temperature.

Furthermore, in the sheet of affixing labels according to the example of the present invention, since the releasing sheet was coated with a layer of clay 50 on one surface, and since the releasing sheet was prepared so as to be heavier than the label sheet, which was coated with a layer of adhesives 30, the label sheet having gaps between labls was never broken at the gaps, when toners were fixed at high temperature.

### EXAMPLE 2

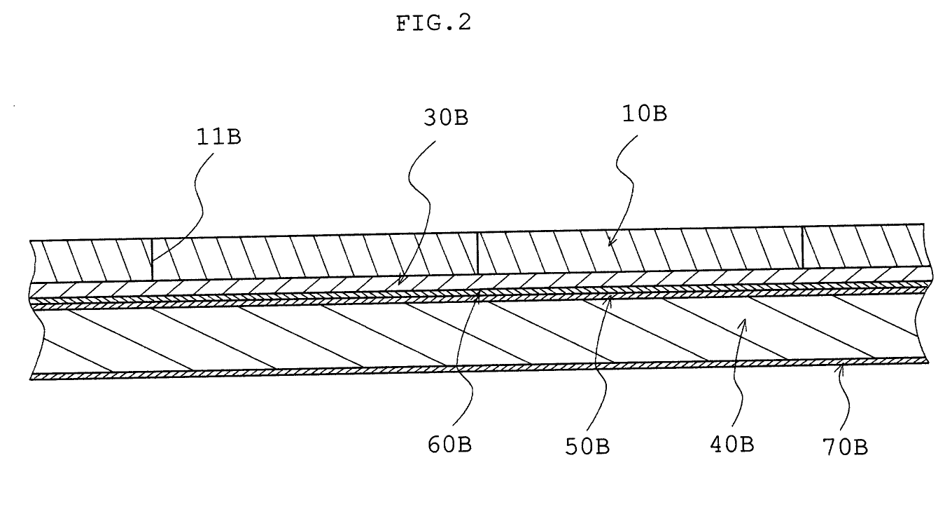

Example 2 of the present invention is shown in FIG. 2.

The sheet of affixing labels according to this example of the present invention comprised a label sheet having a layer of adhesives 30B coated on a sheet of paper 10B and a releasing sheet having a layer of clay 70B coated on the back surface of a sheet of paper 40B and a layer of clay 50B coated on the front surface of the sheet of paper, said layer of clay 50B being further coated with a layer of clay 70B.

The label sheet comprised a water-resistant paper having the thickness of 50 microns and the water absorbing capacity of the cob of less than 30 g/m². The back surface of the sheet of paper 10B was coated with a layer of adhesives of acryl resin 30B having the thickness of 21 microns. The total thickness of the label sheet was 71 microns, and the weight of the label sheet was 60 g/m².

11B showed a gap of the sheet of paper 10B.

The releasing sheet comprised a sheet of wood free paper 40B having the thickness of about 76 microns. The front surface of the sheet of paper 40B was coated with a layer of clay 50B having the thickness of 10 microns, and further coated with a layer of releasing agents of silicon 60B. The back surface of the sheet of paper 40B was coated with a layer of clay 60B having the thickness of 10 microns. The total thickness of the releasing sheet was 99 microns, and the weight of the releasing sheet was 95 g/m².

The sheet of affixing labels according to the example of the present invention had the thickness of 170 microns, as the releasing sheet was superposed on the label sheet, and the releasing sheet was prepared so as to be 35 g/m² heavier than the label sheet.

Accordingly, in the sheet of affixing labels according to the example of the present invention, since the releasing sheet had the layer of clay 50B coated on the front surface of the sheet of paper 40B and the layer of clay 70B coated on the back surface of the sheet of paper 70B, the sheet of affixing labels did not easily curl nor wave, when kept in the custody. Also, since the sheet of affixing labels according to the example of the present invention had the total thickness of 170 microns, separation of the releasing sheet from the label sheet did not occur, when used by means of high speed high temperature a copying machines, laser printer, etc. in which the sheet of affixing labels was reciprocated and turned round.

Also, since the sheet of affixing labels according to the example of the present invention did not comprise substance of thermoplastic resin, the sheet did not curl nor wave, when toners were fixed at high temperature. Furthermore, since the sheet of affixing labels according to the example of the present invention comprised the releasing sheet coated with the layers of clay 50B and clay 70B on both surfaces, and since the releasing sheet was prepared so as to be heavier than the label sheet, the label sheet which has gaps between labels was not broken at one of the gaps, when toners were fixed at high temperature.

Furthermore, in the sheet of affixing labels according to the example of the present invention, since the back surface of the releasing sheet was not coated with anti-static agents but coated with a layer of clay, the sheet of affixing labels was prevented from being sent out of copying or printing machines as being superposed each other, when used by means of high speed copying or printing machines.

### EXAMPLE 3

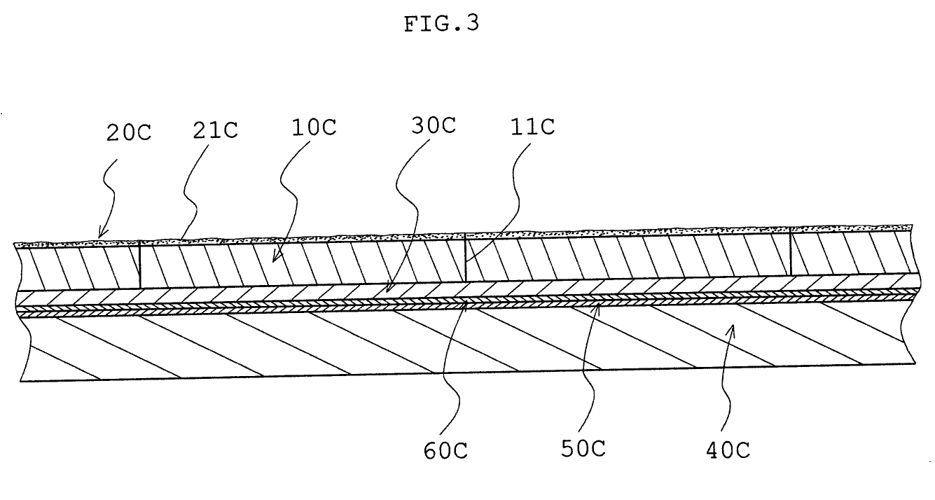

Example 3 of the present invention is shown in FIG. 3.

The sheet of affixing labels according to this example of the present invention comprised a label sheet, which had a layer of matting agents 20C coated on the front surface of polyester resin film 10C and a layer of adhesives 30C coated on the back surface of the polyester resin film 10C, and a releasing sheet which had a layer of clay 50C coated on the front surface of a sheet of paper 40C, said layer of clay 50C being further coated with a layer of releasing agents of silicon 60C.

The label sheet comprised polyester synthetic resin film 10C having the thickness of 50 microns. The front surface of the film 10C was coated a layer of matting agents 20C which included anti-static agents (not shown) and fine particles of silica 21C having an average grain size of less than 0.4 microns, and the back surface of the film 10C was coated with a layer of adhesives of acryl resin 30C having the thickness of 21 microns. The total thickness and the weight of the label sheet were 78 microns and 65 g/m².

11C shows a gap of the film 10C.

The releasing sheet comprised a sheet of wood free paper 40C having the thickness of 76 microns. The front surface of the sheet of paper was coated with a layer of clay 50C having the thickness of 10 microns, and the layer of clay 50C was further coated with a layer of releasing agents of silicon 60C having the thickness of 5 microns. The total thickness and the weight of the releasing sheet were 78 microns and 65 g/m².

The sheet of affixing labels according to the example of the present invention had the thickness of 169 microns, when the label sheet was superposed on the releasing sheet, and releasing sheet was prepared so as to be 15 g/m² heavier than the label sheet.

Accordingly, in the sheet of affixing labels according to the example of present invention, since the releasing sheet was coated with the layer of clay 50C, the sheet of affixing labels did not easily curl nor wave, when kept in the custody. Also, since the sheet of affixing labels had the total thickness of 169 microns, separation of the releasing sheet form the label sheet did not occur, when used by means of high speed high temperature copying or printing machine, laser printer, etc., in which the sheet of affixing labels was to be reciprocated and turned round.

Also, since the sheet of affixing labels according to the example of the present invention did not comprise thermoplastic substance, the sheet did not easily curl nor wave, when toners were fixed at high temperature.

Furthermore, in the sheet of affixing labels according to the example of the present invention, since the releasing sheet had the layer of clay 50C on one side, and since the releasing sheet was prepared so as to be heavier than the label sheet, the sheet of affixing labels was not broken at gaps, when toners were fixed at high temperature.

### EXAMPLE 4

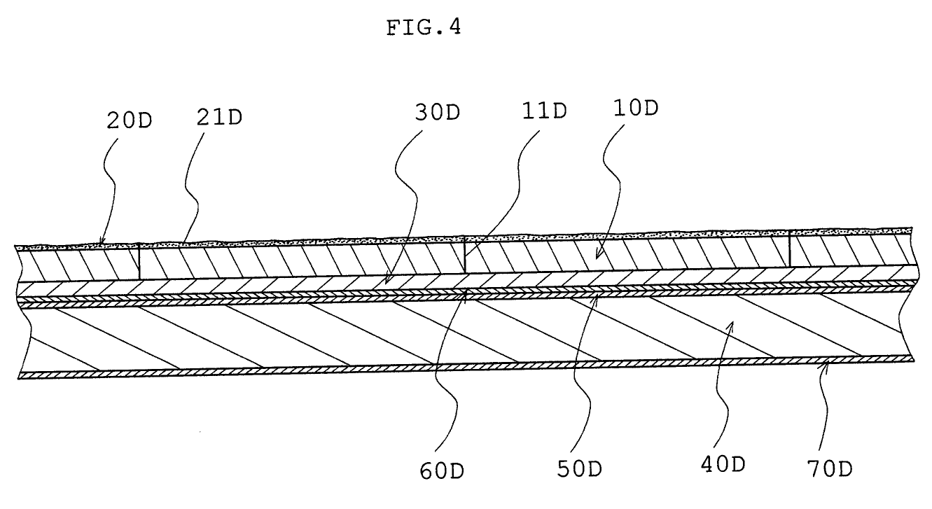

Example 4 of the present invention is shown in FIG. 4.

The sheet of affixing labels according to this example of the present invention comprised a label sheet and a releasing sheet. The label sheet had a layer of matting agents 20D coated on the front surface of polyester resin film 10D and a layer of adhesives 30D coated on the back surface of the film 10D. Also, the releasing sheet had a layer of clay 50D coated on the front surface of a sheet of paper 40D, said layer of clay being further coated with a layer of releasing agents of silicon 60D, and a layer of clay 70D coated on the back surface of the sheet of paper 40D.

The label sheet comprised polyester synthetic resin film 10D having the thickness of 50 microns. The front surface of the film 10D was coated with a layer of matting agents 20D which included anti-static agents (not shown) and fine particles of silica 21D having an average grain size of less than 0.4 microns, and which had the thickness of 7 microns. And the back surface of the film 10D was coated with a layer of adhesives of acryl resin 30D having the thickness of 21 microns. The total thickness and the weight of the releasing sheet were 78 microns and 65 g/m².

11D showed a gap of the film 10D.

The releasing sheet comprised a sheet of wood free paper 40D having the thickness of 76 microns. The front surface of the sheet of paper 40D was coated with a layer of clay 50D, and the layer of clay 50D was coated with releasing agents of silicon 60D having the thickness of 5 microns. The back surface of the sheet of paper 40D was coated with a layer of clay 70D having the thickness of 10 microns. The total thickness and weight of the releasing sheet were 101 microns and 95 g/m².

The sheet of affixing labels according to this example of the present invention had the thickness of 179 microns, as the label sheet was superposed on the releasing sheet, and the releasing sheet was prepared so as to be 30 g/m² heavier than the label sheet.

Accordingly, in the sheet of affixing labels according to the example of the present invention, since the releasing sheet was coated with respective layers of clay 50D and 70D on the both sides, the sheet of affixing labels according to the present invention did not easily curl nor wave, when kept in the custody. Also, since the sheet of affixing labels had the thickness of 179 microns, separation of the releasing sheet from the label sheet did not occur, when used by means of high speed high temperature copying machine, laser printer, etc., in which the sheet of affixing labels was to be reciprocated and turned round.

Also, since the sheet of affixing labels according to the example of the present invention did not comprise thermoplastic substance, the sheet of affixing labels did not curl nor wave, when toners were fixed at high temperature. Furthermore, since the releasing sheet had respective layers of clay 50D and 70D on the both sides, and since the releasing sheet was prepared so as to be heavier than the label sheet which was coated with a layer of adhesives 30D, the sheet of affixing labels was not broken at gaps, when toners were fixed at high temperature.

Furthermore, since in the sheet of affixing labels according to the example of the present invention, the back surface of the releasing sheet was not coated with anti-static agents but coated with clay, the sheet of affixing labels was not sent out of copying or printing machines as two or more sheets being superposed, when the sheet of affixing labels was moved at high speed in the copying or printing machines.

### ADVANTAGES

The sheet of affixing labels according to the present invention was not curled nor waved nor broken, when kept in the custody, or when used by means of a copying machine, laser printer, etc. in which toners are to be fixed at high speed and at high temperature. Also, separation of the label sheet from the releasing sheet does not occur, when used by means of a copying machine, laser printer, etc. in which the sheet of affixing labels is to be reciprocated and turned round.

Furthermore, although the surface of the sheet of affixing labels is not coated with anti-static agents, the sheet is not sent out of a copying machine, laser printer, etc. as two or more sheets are superposed.

Also, the sheet of affixing labels according to the present invention can be manufactured cheaply and simply as compared with former sheets, and the sheet of affixing labels comprising a sheet of water-resisting paper is expected to be used on a large scale for outdoor use.

In addition, the sheet of affixing labels according to the present invention does not occur environmental pollution and the sheet can be treated so that it may be fed back.

I claim:

1. A sheet of affixing labels comprising a label sheet having a layer of adhesives coated on the back surface of a sheet of paper and a releasing sheet having a layer of clay coated on the surface of a sheet of paper, said layer of clay being further coated with a layer of releasing agents of silicon.

2. A sheet of affixing labels comprising a label sheet having a layer of adhesives coated on the back surface of a sheet of paper and a releasing sheet having a layer of clay coated on the back surface of a sheet of paper and a layer of clay coated on the front surface of the sheet of paper, said layer of clay further coated with a layer of releasing agents.

3. A sheet of affixing labels as claimed in claim 1 or 2, wherein the releasing sheet comprises a sheet of paper having the water absorbing capacity of the cob of less than 30 g/m².

4. A sheet of affixing labels comprising a label sheet made of a polyester synthetic resin film, which has the front surface coated with a layer of matting agents including anti-static agents and fine particle and the back surface coated with a layer of adhesives, and a releasing sheet made of a sheet of paper which has the front surface coated with a layer of clay, said layer of clay further coated with a layer of releasing agents of silicon.

5. A sheet of affixing labels comprising a label sheet made of a polyester synthetic resin film, which has the front surface coated with a layer of matting agents including anti-static agents and fine particles and the back surface coated with a layer of adhesives, and a releasing sheet made of a sheet of paper which has the back surface coated with a layer of clay and the front surface coated with a layer of clay which is further coated with a layer of releasing agents of silicon.

6. A sheet of affixing labels as claimed in claim 4 or 5, wherein the label sheet is prepared so as to be 15 g/m² to 35 g/m² heavier than the releasing sheet so that the label sheet may be prevented from being broken easily at a gap.
